(19) United States
(12) Patent Application Publication
(10) Pub. No.: US 2020/0364752 A1
(43) Pub. Date: Nov. 19, 2020

(54) STOREFRONT DEVICE, STOREFRONT SYSTEM, STOREFRONT MANAGEMENT METHOD, AND PROGRAM

(71) Applicant: NEC CORPORATION, Tokyo (JP)

(72) Inventors: Takahiro OKAMOTO, Tokyo (JP); Shinya YAMASAKI, Tokyo (JP)

(73) Assignee: NEC CORPORATION, Tokyo (JP)

(21) Appl. No.: 16/640,275

(22) PCT Filed: Mar. 14, 2018
(86) PCT No.: PCT/JP2018/009927

§ 371 Date: Feb. 19, 2020

(30) Foreign Application Priority Data
Aug. 25, 2017 (JP) 2017-162610

(51) Int. Cl. G06Q 30/02; G06F 3/01; G09F 27/00

(52) U.S. Cl. CPC G06Q 30/0272; G06Q 30/0271; G09F 2027/001; G06F 3/017; G09F 27/005; G06Q 30/0268

(57) ABSTRACT

A storefront device comprising a display device specifying unit configured to specify, among a plurality of display devices, a display device for displaying sales management information indicating merchandise acquired in a storefront by a processing subject person detected in the storefront; and a display timing determination unit configured to determine a timing at which the sales management information is to be displayed on the specified display device.

### TECHNICAL FIELD

The present invention relates to a storefront device, a storefront system, a storefront management method, and a program.

### BACKGROUND ART

Technology is sought for managing automatic payments for merchandise that a customer wishes to purchase in a storefront. Patent Document 1 discloses, as related art, technology relating to an unmanned storefront.

### CITATION LIST

### Patent Literature

### [Patent Document 1]

Japanese Unexamined Patent Application, First Publication No. 11-25337

### SUMMARY OF INVENTION

### Problem to be Solved by the Invention

In a storefront in which automatic payments for merchandise are implemented as mentioned above, people such as customers walk around in the storefront while carrying merchandise that has been taken in his/her hand and put in bags or baskets. A computer server device provided in the storefront for implementing the automatic payments detects and manages, for each customer, the merchandise taken in the hand of the customer, based on information obtained from various sensors in the storefront. The customer is also able to display, on a mobile terminal that communicates with the computer server device, a list of the merchandise acquired by the customer. However, a customer not holding a portable terminal cannot check information, such as the merchandise taken in the hand of that customer, managed by the computer server device.

Thus, an objective of the present invention is to provide a storefront device, a storefront system, a storefront management method and a program that can solve the above-mentioned problem.

### Means for Solving the Problem

According to a first aspect of the present invention, a storefront device includes: a display device specifying unit configured to specify, among a plurality of display devices, a display device for displaying sales management information indicating merchandise acquired in a storefront by a processing subject person detected in the storefront; and a display timing determination unit configured to determine a timing at which the sales management information is to be displayed on the specified display device.

According to a second aspect of the present invention, a storefront system includes a storefront device configured to specify, among a plurality of display devices, a display device for displaying sales management information indicating merchandise acquired in a storefront by a processing subject person detected in the storefront, and determine a timing at which the sales management information is to be displayed on the specified display device.

According to a third aspect of the present invention, a storefront management method includes specifying, among a plurality of display devices, a display device for displaying sales management information indicating merchandise acquired in a storefront by a processing subject person detected in the storefront, and determining a timing at which the sales management information is to be displayed on the specified display device.

According to the fourth aspect of the present invention, a program causes a computer of a storefront device to execute processes. The processes includes specifying, among a plurality of display devices, a display device for displaying sales management information indicating merchandise acquired in a storefront by a processing subject person detected in the storefront, and determining a timing at which the sales management information is to be displayed on the specified display device.

### Advantageous Effects of Invention

According to the present invention, it is possible for a person visiting a storefront to purchase merchandise while viewing, in display devices in the storefront, sales management information including at least a list of the names of merchandise taken in the hand of that person.

### BRIEF DESCRIPTION OF DRAWINGS

FIG. 1 is a schematic diagram of a storefront system according to an embodiment of the present invention.

FIG. 2 is a diagram illustrating merchandise shelves and a user acquiring merchandise from a merchandise shelf according to the embodiment of the present invention.

FIG. 3 is a hardware configuration diagram for a storefront device according to the embodiment of the present invention.

FIG. 4 is a functional block diagram of a storefront device according to the embodiment of the present invention.

FIG. 5 is a first diagram illustrating the processing flow in a storefront device according to the embodiment of the present invention.

FIG. 6 is a second diagram illustrating the processing flow in a storefront device according to the embodiment of the present invention.

FIG. 7 is a diagram illustrating the minimum configuration for a storefront device according to the embodiment of the present invention.

### DESCRIPTION OF EMBODIMENTS

Hereinafter, a storefront device according to an embodiment of the present invention will be explained with reference to the drawings.

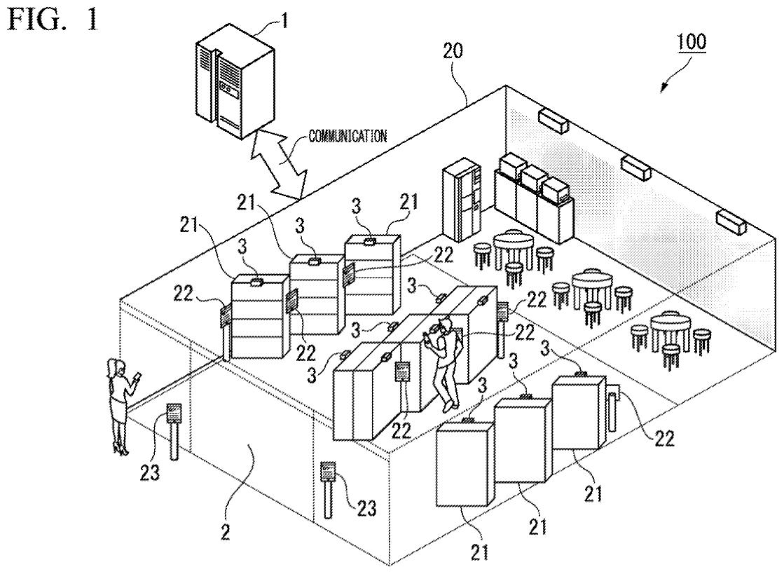

FIG. 1 is a schematic diagram of a storefront system provided with the storefront device according to the present embodiment.

The storefront device 1 is communicably connected to devices provided in a storefront 20. The storefront 20 is provided, for example, with an entrance/exit gate 2. Additionally, a plurality of merchandise shelves 21 are provided in the storefront 20. Merchandise is arranged on each merchandise shelf 21. Furthermore, as one example, display devices 22 corresponding to each of the merchandise shelves 21 are provided in the storefront 20. The display devices 22 may be provided in the storefront without being associated with the merchandise shelves 21. As one example, the display devices 22 are computers provided with touch panels, such as tablet terminals. The merchandise shelves 21 are provided with first cameras 3 for capturing images of the faces of people positioned in front of the merchandise shelves. In addition thereto, sensing devices such as merchandise detection sensors 6 are provided in the storefront 20, and these will be explained in detail below.

The storefront 20 that is managed by the storefront system 100 according to the present embodiment has a structure in which a user enters or exits the store by passing through an entrance/exit gate 2. It is not necessary for an employee to always be stationed at the storefront 20. It is also possible for an employee to always be stationed at the storefront 20. A user takes merchandise from merchandise shelves 21 in his/her hand, and exits the store through the entrance/exit gate 2. Until the user exits the store through the entrance/exit gate 2, sensing devices such as image capture devices and motion sensors provided in the store acquire and transmit, to the storefront device 1, sensing information for determining feature information and position information of the user, identification information and the positions of the merchandise acquired by the user, or the like. The storefront device 1 uses the received sensing information to automatically perform a payment process.

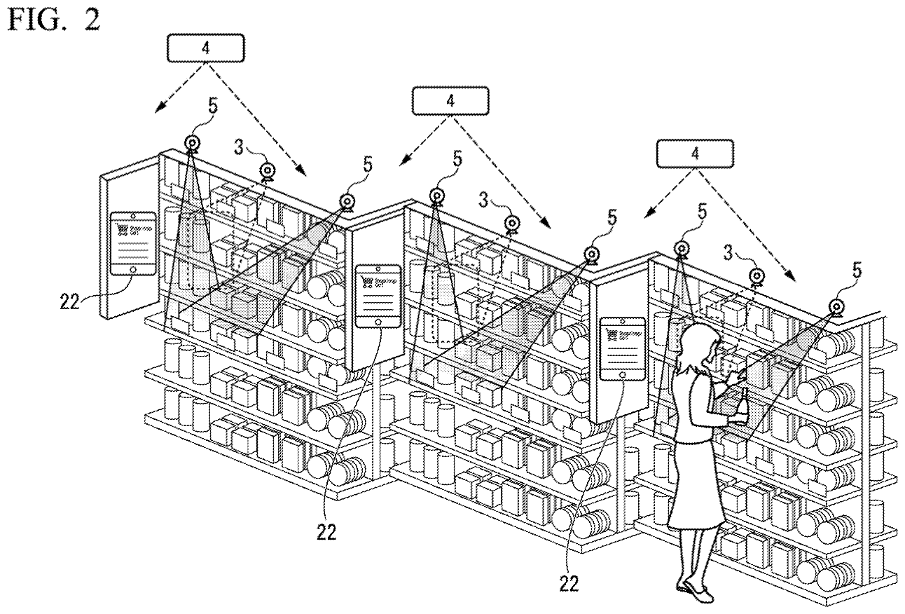

FIG. 2 is a diagram illustrating merchandise shelves and a user acquiring merchandise from a merchandise shelf.

A plurality of first cameras 3 may be provided on each merchandise shelf 21. Additionally, a motion sensor 4 for sensing the motion of the user may be provided above the merchandise shelf 21. Additionally, second cameras 5 for capturing images of merchandise taken in the hand of a user of the storefront 20 and merchandise returned to the merchandise shelf 21 may be provided above the merchandise shelf 21. The second cameras 5 may be provided as cameras for recognizing merchandise, separate from the cameras for capturing images of the faces of people and recognizing the people.

The first cameras 3 and the second cameras 5 do not need to be provided on the merchandise shelves 21. The first cameras 3 and the second cameras 5 may be provided anywhere, such as in the ceiling or in the floor, as long as they are positions from which it is possible to capture facial images, images of merchandise taken in the hand of a user, and images of merchandise returned to the merchandise shelves 21.

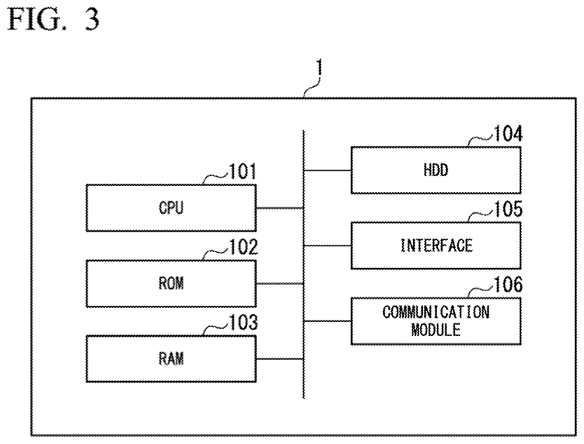

FIG. 3 is a hardware configuration diagram for a storefront device.

As illustrated in FIG. 3, the storefront device 1 is provided, as an example, with hardware features including a CPU (Central Processing Unit) 101, a ROM (Read Only Memory) 102, a RAM (Random Access Memory) 103, an HDD (Hard Disk Drive) 104, an interface 105 and a communication module 106. The HDD 104 may be an SSD (Solid State Drive).

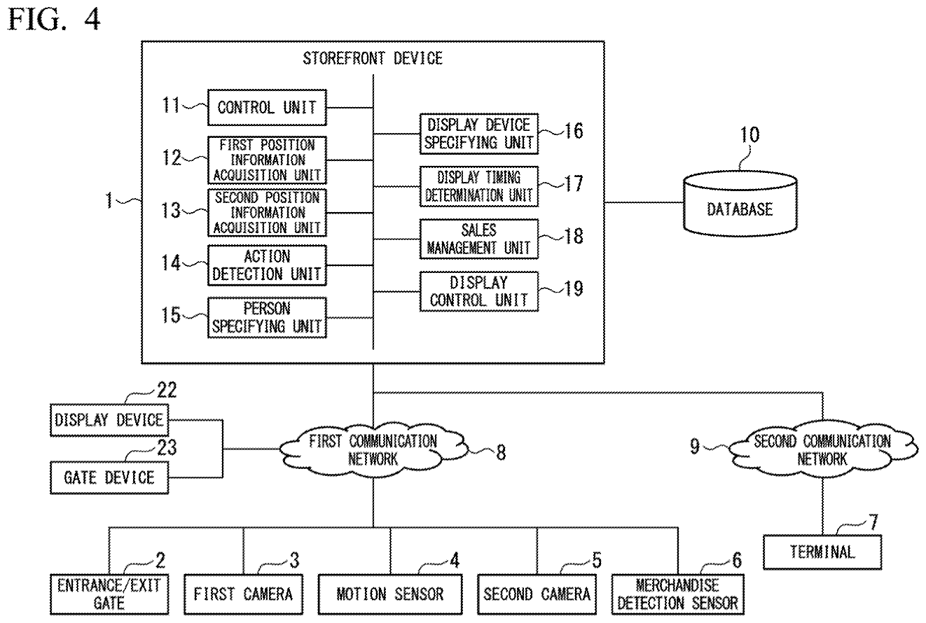

FIG. 4 is a functional block diagram of a storefront device.

The CPU 101 of the storefront device 1 reads and executes a storefront management program that is pre-recorded in a storage unit. As a result thereof, the storefront device 1 is provided with the functions of a control unit 11, a first position information acquisition unit 12, a second position information acquisition unit 13, an action detection unit 14, a person specifying unit 15, a display device specifying unit 16, a display timing determination unit 17, a sales management unit 18 and a display control unit 19.

As illustrated in FIG. 4, the storefront device 1 is connected to a database 10. The storefront device 1 is communicably connected, via a first communication network 8, to the sensing devices provided inside the storefront 20, such as the entrance/exit gate 2, the first cameras 3, the motion sensors 4, the second cameras 5, the merchandise detection sensors 6, the display devices 22 and a gate device 23. The first communication network 8 is, for example, a dedicated communication network for connecting the storefront device 1 with the sensing devices in the storefront 20. The storefront device 1 is also connected, via a second communication network 9, to a terminal 7 carried by the user of the storefront 20. The second communication network 9 is a mobile telephone network or the internet. The storefront device 1 may be a computer server device provided in the storefront, or may be a computer server device installed in a computer data center or the like located remotely from the storefront 20.

Due to the above-mentioned functions of the storefront device 1 according to the present embodiment, the storefront device 1 specifies a processing subject person from among users positioned near a display device 22. In other words, the storefront device 1 specifies a user positioned within a prescribed range from any of the plurality of display devices 22 as a processing subject person. Furthermore, the storefront device 1 specifies, from among a plurality of display devices 22 provided in the storefront, a display device 22 displaying sales management information indicating merchandise acquired in the storefront 20 by the processing subject person detected in the storefront 20. Additionally, the storefront device 1 determines the timing at which sales management information is to be displayed on the specified display device 22. Additionally, the storefront device 1 implements control so that, at the determined timing, the sales management information is transmitted to the specified display device 22, and said sales management information is displayed on the display device 22. Additionally, based on prescribed actions by the processing subject person, the storefront device 1 instructs the display device 22 that displayed the sales management information to erase the sales management information.

Due to these processes by the storefront device 1, a user is able to check, on a display device 22 installed in the storefront 20, sales management information indicating merchandise taken in the hand of that user, or merchandise placed in a basket or a bag.

The storefront device 1 acquires first position information indicating the positions of biological feature information of approaching people who are nearing merchandise, on the basis of images obtained from the first cameras 3. The biological feature information may, for example, be feature information relating to the face, or feature information relating the irises in the eyes. The approaching people may be store users, such as customers, or may be a manager who manages the storefront 20. Additionally, based on sensing information obtained from a motion sensor 4, the storefront device 1 detects second position information indicating the position of a subject person, among the merchandise-approaching people, who has stretched an arm towards merchandise.

The storefront device 1 detects merchandise movement actions. For example, the storefront device 1 detects the merchandise movement actions based on images from the second cameras 5 that capture images of merchandise, and information obtained from the merchandise detection sensors 6. The merchandise movement actions are actions for taking merchandise in the hand, actions for returning merchandise to the merchandise shelves 21, or the like. The storefront device 1 specifies the biological feature information for a processing subject person who has performed a merchandise movement action based on an ID and the position of the merchandise on which the movement action was performed, and the positional relationship between the first position information and the second position information. The storefront device 1 acquires the ID of a person corresponding to that feature information. The storefront device 1 manages sales management information or the like corresponding to the ID of the specified subject person, such as by assigning identification information for the merchandise on which the movement action was performed.

The process for detecting the merchandise movement actions in the storefront device 1 will be explained.

When a user of the storefront 20 passes through the entrance/exit gate 2, the face of the user is oriented towards the gate device 23. The gate device 23 has an image capture function and captures an image of the user. The gate device 23 transmits, to the storefront device 1, an image in which the user's face appears. The sales management unit 18 generates facial feature information from the image obtained by the gate device 23. The sales management unit 18 determines whether or not feature information contained in a list of users recorded in the database 10 matches the feature information obtained from the gate device 23. If the feature information acquired by the gate device 23 matches any of the feature information recorded in the database 10, then the sales management unit 18 transmits a signal indicating that there is a match to the gate device 23. The gate device 23 detects that the feature information has been matched, and implements control to open the gate.

If the feature information obtained from the gate device 23 is not included in the feature information contained in the user list recorded in the database 10, then the sales management unit 18 may newly record the feature information obtained from the gate device 23 in the database 10 and output a gate-opening instruction to the gate device 23. In this case, the gate device 23 may prompt the user to input information such as a credit card number or a PIN number, and may implement control to open the gate after this information has been obtained. The sales management unit 18 writes a user ID linked to the user's feature information in a sales management table recorded in the database 10. As a result thereof, the sales management unit 18 can prepare a user to purchase merchandise in the storefront 20. The sales management table is a data table that stores, in an associated manner, information such as user IDs, the IDs of merchandise taken in the hands of users, the number of items of merchandise, and the like. At the time a user enters the storefront 20, there is no merchandise information, such as merchandise IDs, stored so as to be linked to the user ID in the sales management table.

When a user in the storefront takes an item of merchandise in the hand and places it in a basket or the like, a first camera 3 captures an image of a person, such as a user, positioned in front of the merchandise shelf 21, and outputs the captured image or video image to the storefront device 1. A motion sensor 4, in one example, senses a user below from above the merchandise shelf 21, such as from the ceiling, and outputs information obtained by the sensing process to the storefront device 1.

The information sensed and output by the motion sensor 4 may, for example, be a range image or the like obtained by converting, to an image, the ranges to the positions of objects, obtained by means of infrared rays.

A merchandise detection sensor 6 is installed, for example, for each item of merchandise displayed on a merchandise shelf 21. The merchandise detection sensors 6 may specifically be in the shapes of sheets that are laid underneath the merchandise, and may be pressure sensors for detecting pressure due to the weight of the merchandise at each position set on the sheet, or may be weight sensors for detecting the weight itself. When, for example, a user takes merchandise in the hand, a merchandise detection sensor 6 outputs, to the storefront device 1, a merchandise acquisition signal including the sensor ID of that merchandise detection sensor 6 and coordinates in the storefront of that merchandise on the merchandise shelf 21. The storefront device 1 specifies a personal ID on the basis of the correspondence between the time and the storefront three-dimensional coordinates linked to each of acquired information, and the correspondence between the time, the storefront three-dimensional coordinates and the merchandise ID stored so as to be linked with the sensor ID of the merchandise detection sensor 6, received from the merchandise detection sensor 6. The acquired information is personal feature information based on the images obtained by the first cameras 3, personal skeletal frame information based on the images obtained by the motion sensors 4, and merchandise information, such as merchandise IDs, based on the images obtained by the second cameras 5.

The storefront device 1 records, in a linked manner, the specified personal ID and the merchandise ID specified by the images taken by the second camera 5, in a sales management table in the database 10.

When the merchandise is returned to a merchandise shelf 21, the merchandise detection sensor 6 outputs, to the storefront device 1, merchandise return action information including the sensor ID of that merchandise detection sensor 6 and the coordinates in storefront of that merchandise on the merchandise shelf 21. The storefront device 1 performs a process for unlinking the corresponding user ID and merchandise ID recorded in the database 10. Specifically, the storefront device 1 performs a process for unlinking the corresponding personal ID of the user and the merchandise ID on the basis of the merchandise ID and the coordinates stored so as to be linked to the sensor ID of the merchandise detection sensor 6 indicated by that merchandise return action information, and the feature information or skeletal frame information of the processing subject person.

The storefront device 1 may detect the identification information for merchandise taken in the hand by the user or the coordinates in the storefront of that merchandise on the merchandise shelf 21 on the basis of images obtained from the second cameras 5 instead of the information obtained from the merchandise detection sensors 6. Additionally, the storefront device 1 may detect the identification information of merchandise returned to a merchandise shelf 21 and the coordinates in the storefront of that merchandise on the merchandise shelf 21 based on images obtained from the second cameras 5. In other words, the storefront device 1 only needs to detect merchandise movement actions based on either the merchandise detection sensors 6 or the images obtained from the second cameras 5. A movement action refers to an action by a user to acquire merchandise from a merchandise shelf 21, or an action to return the merchandise to the merchandise shelf 21.

Due to such processes, the storefront device 1 is able to analyze and store information regarding which merchandise the user has taken in the hand and which merchandise has been returned to the merchandise shelf 21. Additionally, the user passes through the entrance/exit gate 2. At this time, the gate device 23 captures an image of the face of the user exiting the store. The gate device 23 transmits, to the storefront device 1, store exit information including a store exit flag and images in which the user's face appears. The sales management unit 18 generates facial feature information on the basis of the images obtained from the gate device 23. The sales management unit 18 determines whether or not feature information contained in a list of users recorded in the database 10 matches the feature information obtained from the gate device 23. If the feature information acquired from the gate device 23 matches any of the feature information recorded in the database 10, then a signal indicating that there is a match is transmitted to the gate device 23. As a result thereof, the gate device 23 implements control to open the gate of the entrance/exit gate 2.

Additionally, based on the feature information of the user exiting the store, the sales management unit 18 reads the ID of the user from the database 10. Based on this user ID, the sales management unit 18 specifies the relationship between that user ID and merchandise IDs included in the sales management information recorded in the sales management table. Furthermore, the sales management unit 18 can automatically detect the merchandise to be purchased by the user exiting the store. The storefront device 1 automatically performs a payment process using the sales management information including the user IDs and the merchandise IDs recorded in the sales management table in the database 10, and a credit card number or the like to be used for payment, acquired from the database 10 on the basis of the user ID. The above-mentioned processes of the respective devices in the storefront 20 and the above-mentioned processes of the storefront device 1 performed from when the user enters the storefront 20 until the user leaves are merely one example. The processes for detecting merchandise purchased by the user may be performed on the basis of other processes.

As mentioned above, the storefront device 1 detects actions in which a user acquires merchandise from a merchandise shelf 21 and actions in which the user returns merchandise to the merchandise shelf 21. However, there is a need to raise the recognition precision for recognizing which person acquired which merchandise. For example, when there are a plurality of people positioned in front of a merchandise shelf 21 and one of those people has taken a specific item of merchandise in the hand, the storefront device 1 cannot automatically proceed with a merchandise purchase process unless it is recognized, with high precision, which person has taken which item of merchandise.

Hereinafter, technology for raising the recognition precision for recognizing which person took which item of merchandise will be explained. The storefront device 1 may also determine which items of merchandise have been acquired by people, such as employees, other than people visiting the store for the purpose of purchasing merchandise. Furthermore, the storefront device 1 implements control to display, on a display device 22 installed in the storefront 20, sales management information indicating a list of merchandise that a person recognized in this manner is to purchase. As a result thereof, it is possible to notify users not possessing their own mobile terminals of information regarding merchandise taken in the hand to be purchased by that user, the monetary amounts thereof, and the like.

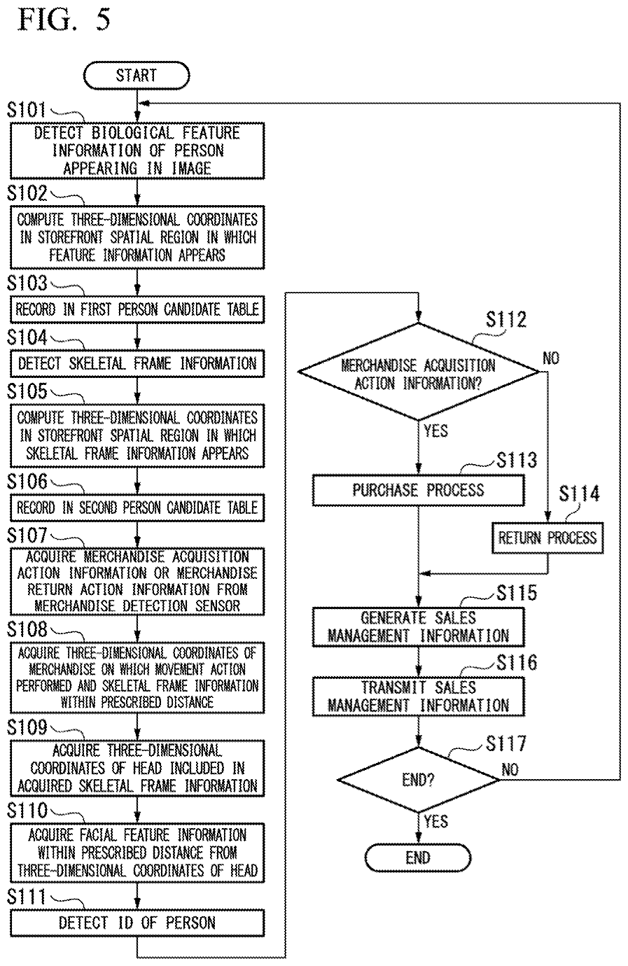

FIG. 5 is a first diagram illustrating the processing flow in a storefront device.

The first position information acquisition unit 12 in the storefront device 1, as an example, acquires several to several tens of images per second from each of a plurality of first cameras 3. The plurality of first cameras 3 are installed in the respective merchandise shelves 21 so as to be able to capture images of people positioned in from of the shelves. The first position information acquisition unit 12 detects biological feature information for the people appearing in the acquired images (step S101). The biological information may, for example, be feature information relating to the face, or feature information relating to the irises in the eyes. The first position information acquisition unit 12, upon successfully acquiring biological feature information from the images, computes the spatial coordinates at which the feature information was successfully detected. For example, suppose that, for the first position information acquisition unit 12, three-dimensional image capture spatial regions are predetermined based on angles of view and shooting directions.

The first position information acquisition unit 12 acquires, from the database 10, a three-dimensional image capture spatial region for each first camera 3. The first position information acquisition unit 12 computes the three-dimensional coordinates, within a three-dimensional image capture spatial region, at which feature information appears, by means of a prescribed computational expression, on the basis of the acquired three-dimensional image capture spatial region, the coordinates within the image of the feature information appearing in the image, the size of the feature information, and the like. Additionally, the first position information acquisition unit 12 uses a conversion expression, for converting coordinates in the three-dimensional image capture spatial region to coordinates indicating storefront spatial regions, to compute the three-dimensional coordinates, within a storefront spatial region, at which the feature information appears (step S102).

When biological feature information has been successfully acquired from an image, the first position information acquisition unit 12 records, in a first person candidate table, in an associated manner, the ID of the first camera 3 that transmitted the image, the detection time, the biological feature information, and the three-dimensional coordinates, within a storefront spatial region, at which the feature information appeared (step S103). The first position information acquisition unit 12 updates the information in the first person candidate table each time an image is acquired.

The second position information acquisition unit 13, as an example, acquires several to several tens of range images per second from a plurality of motion sensors 4. The plurality of motion sensors 4 are provided in the ceiling or the like above the merchandise shelves 21, and are installed so as to be able to capture images, facing downwards from above, of people positioned in front of the shelves. The second position information acquisition unit 13 analyzes the images of people appearing in these acquired range images, and detects skeletal frame information, such as the positions of heads and the axes of arms stretched out by people in the images (step S104). The skeletal frame information may include vectors and coordinates indicating straight lines representing arm axes, and the coordinates of the tips of hands obtained by analysis of the range images. The skeletal frame information includes at least coordinates or vectors, or expressions representing the axes of arms for specifying the positions, within coordinates, of the head, arms or tips of the hands viewed from above.

When skeletal frame information including an arm axis and a hand tip have been successfully acquired from an image, the second position information acquisition unit 13 computes the spatial coordinates of the arm or the hand tip indicating the skeletal frame information. As with the first position information acquisition unit 12, the second position information acquisition unit 13 pre-stores three-dimensional image capture spatial regions based on angles of view and shooting directions. The second position information acquisition unit 13 acquires, from the database 10, a three-dimensional image capture spatial region for each motion sensor 4. The second position information acquisition unit 13 computes, by means of a prescribed computational expression, the three-dimensional coordinates, within a three-dimensional image capture spatial region, at which skeletal frame information appears, on the basis of the acquired three-dimensional image capture spatial region, the coordinates within the image of the skeletal frame information appearing in the image, the distance from the motion sensor 4, and the like. Additionally, the second position information acquisition unit 13 uses a conversion expression for converting coordinates in the three-dimensional image capture spatial region to coordinates indicating storefront spatial regions to compute the three-dimensional coordinates, within a storefront spatial region, at which the skeletal frame information appears (step S105).

When skeletal frame information has been successfully acquired from an image, the second position information acquisition unit 13 records, in a second person candidate table, in an associated manner, the ID of the motion sensor 4 that transmitted the image, the detection time, the skeletal frame information, and the three-dimensional coordinates, within a storefront spatial region, at which the skeletal frame information appeared (step S106). The second position information acquisition unit 13 updates the information in the second person candidate table each time a range image is acquired.

The merchandise detection sensor 6, as one example, detects the weight of merchandise or pressure due to said weight. Based on increases, decreases and the like in the weight or pressure, if there is a weight or pressure decrease of a threshold value or more, then the merchandise detection sensor 6 outputs, to the storefront device 1, merchandise acquisition action information including a flag indicating a decrease, a sensor ID, a merchandise arrangement position (merchandise shelf ID, positioned rack number or the like) and an action detection time. Additionally, based on the weight or pressure increases, decreases and the like, if there is a weight or pressure increase of a threshold value or more, then the merchandise detection sensor 6 outputs, to the storefront device 1, merchandise return action information including a flag indicating an increase, a sensor ID, a merchandise arrangement position and an action detection time.

The action detection unit 14 in the storefront device 1 acquires merchandise acquisition action information and merchandise return action information from the merchandise detection sensor 6 (step S107). The action detection unit 14, based on merchandise acquisition action information, acquires a merchandise ID stored so as to be linked to the sensor ID included in the merchandise acquisition action information. As a result thereof, the action detection unit 14 detects that the merchandise having that merchandise ID has been acquired from the merchandise shelf 21 indicated by the arrangement position. Additionally, the action detection unit 14, based on merchandise return action information, acquires a merchandise ID stored so as to be linked to the sensor ID included in the merchandise acquisition action information. As a result thereof, the action detection unit 14 detects that the merchandise having that merchandise ID has been returned to the merchandise shelf 21 indicated by the arrangement position. The action detection unit 14 outputs, to the person specifying unit 15, the merchandise ID, the arrangement position and the action detection time corresponding to the sensor ID included in the merchandise acquisition action information or the merchandise return action information.

Upon acquiring, from the action detection unit 14, the merchandise ID, the arrangement position and the action detection time for the movement action, the person specifying unit 15 performs the determination process described next. In other words, the person specifying unit 15 determines whether or not the second person candidate table has, recorded therein, skeletal frame information that includes coordinates that are close, to within a prescribed distance, to the three-dimensional coordinates in the storefront spatial region indicated by the arrangement position, and that is linked to a detection time within a prescribed time difference relative to the action detection time. When there is, recorded in the second person candidate table, skeletal frame information that includes coordinates close, to within a prescribed distance, to the three-dimensional coordinates of the merchandise on which the movement action was performed, and that is linked to a detection time within a prescribed time difference relative to the action detection time, the person specifying unit 15 acquires that skeletal frame information (step S108).

For example, the skeletal frame information includes the three-dimensional coordinates of the tip of a hand. When the three-dimensional coordinates of an item of merchandise and the three-dimensional coordinates of the tip of the hand approach close to each other at about the same time, the person specifying unit 15 infers that the skeletal frame information including the three-dimensional coordinates of that hand tip is skeletal frame information of the person that took the item of merchandise in the hand, and acquires that skeletal frame information. Therefore, based on the three-dimensional coordinates of an item of merchandise on which a movement action has been performed, the person specifying unit 15 acquires the three-dimensional coordinates of a head included in the skeletal frame information acquired as mentioned above, and the detection time of that skeletal frame information (step S109).

The person specifying unit 15 acquires, from the first person candidate table, facial feature information that is linked to three-dimensional coordinates within a prescribed distance from the three-dimensional coordinates of the head, and that has a detection time within a prescribed time difference (step S110). It is assumed that the storefront device 1 pre-stores, in a personal feature table in the database 10, facial feature information linked to personal IDs. Based on that stored information, the person specifying unit 15 uses the facial feature information acquired from the skeletal frame information and detects a personal ID (step S111).

According to the above-mentioned processes, the storefront device 1 detects positions based on the motions of the arms or hands of people that have acquired merchandise from merchandise shelves 21 and the positions of merchandise on which movement actions have been performed. The storefront device 1 determines which merchandise has been acquired by which person, and which merchandise has been returned by which person on the basis of the correspondence relationship between the positions based on the motions of the arms or hands of the people and the positions of the merchandise. Due to such processes, it is possible to determine, more precisely than in the conventional art, which merchandise has been acquired by which person, and which merchandise has been returned by which person.

During the processing for acquiring the merchandise acquisition action information and the merchandise return action information indicated by step S107 above, the storefront device 1 may determine, based on images obtained from the second cameras 5, whether a merchandise acquisition action or a merchandise return action has been performed. For example, the action detection unit 14 acquires, as one example, about several to several tens of images per second from each of the second cameras 5. The second cameras 5 have angles of view aligned with the ranges of the respective merchandise shelves 21, and capture images of merchandise placed on said shelves.

Based on image data of each item of merchandise placed on the merchandise shelves 21, the action detection unit 14 sequentially detects, by pattern matching or the like, or by movement analysis, the before/after movement amounts and presence/absence of merchandise for each of the items of merchandise appearing in the images, and specifies the items of merchandise that have moved. Additionally, for example, when merchandise that was arranged on a merchandise shelf 21 is gone in images that have been received before and after, it is determined that the merchandise has been acquired. On the other hand, when there is merchandise that was not present arranged on a merchandise shelf 21 in images that have been received before and after, it is determined that the merchandise has been returned to the merchandise shelf 21.

Furthermore, upon determining that merchandise has been acquired, the action detection unit 14 generates merchandise acquisition action information including the ID of that merchandise and the arrangement position of the merchandise. The merchandise ID may be an ID that is recorded so as to be linked to image data of the merchandise in a database 10 or the like. Additionally, the merchandise arrangement position may be the three-dimensional coordinates in a storefront spatial region computed on the basis of the coordinates in an image captured by a second camera 5. Upon determining that merchandise has been returned to a merchandise shelf 21, the action detection unit 14 generates merchandise return action information including the ID of that merchandise and the arrangement position of the merchandise. The action detection unit 14 outputs, to the person specifying unit 15, the merchandise ID or arrangement position included in the merchandise acquisition action information or the merchandise return action information. The subsequent processing by the person specifying unit 15 may be a process similar to the above-mentioned person specifying process performed by using the coordinates of merchandise on which the movement actions obtained from the merchandise detection sensors 6 have been performed.

As illustrated in FIG. 2, a plurality of second cameras 5 for capturing images of merchandise may be installed on the merchandise shelves 21, and the action detection unit 14 may determine the merchandise on which movement actions have been performed based on images captured by each of the second cameras 5. The second cameras 5 may be installed not only on the merchandise shelves 21, but also in the ceiling or in the floor. The merchandise recognition precision can be raised by capturing images of the merchandise on which movement actions have been performed from separate directions by a plurality of the second cameras 5, and analyzing multiple images. In this case, the action detection unit 14 sequentially acquires, from a plurality of second cameras 5, respective images capturing, from different directions, the merchandise on which a movement action has been performed. The action detection unit 14 detects the merchandise in the images acquired by the plurality of second cameras 5 by pattern matching. Additionally, the action detection unit 14 determines the three-dimensional coordinates of that merchandise by computing the three-dimensional coordinates of the merchandise appearing in the images by substituting information such as the shooting direction, the angle of view and the size of the merchandise into a computational expression. When the same merchandise appearing in images acquired by each of a plurality of second cameras 5 capturing images of the same merchandise shelf 21 is detected at the same time, the action detection unit 14 recognizes that these are a single item of merchandise. Furthermore, the action detection unit 14 recognizes a movement action of the single item of merchandise based on the multiple images. The database 10 records feature information and image information for the cases in which each item of merchandise is viewed from multiple different angles. The action detection unit 14 uses such merchandise feature information and image information recorded in the database 10 and recognizes the merchandise appearing in images newly captured by the second cameras 5.

Upon detecting the ID of the person who performed the merchandise movement action in step S111, the person specifying unit 15 outputs sales management information to the sales management unit 18. The sales management information includes the ID of that person and merchandise acquisition action information or merchandise return action information, which is information indicating the movement action. From the sales management information, the sales management unit 18 acquires a personal ID and merchandise acquisition action information or merchandise return action information. The sales management unit 18 determines whether, between merchandise acquisition action information and merchandise return action information, merchandise acquisition action information has been acquired (step S112). When the sales management information includes merchandise acquisition action information (YES in step S112), the sales management unit 18 performs a purchase process (step S113). In other words, the sales management unit 18 performs a purchase process wherein one merchandise ID, which is included in the merchandise acquisition action information, is added to merchandise information recorded in a sales management table in the database 10 so as to be linked to the personal ID. In this way, it is recorded in the database 10 that the person indicated by the personal ID has purchased the merchandise.

On the other hand, when the sales management information includes merchandise return action information (NO in step S112), the sales management unit 18 performs a return process (step S114). In other words, the sales management unit 18 performs a return process that involves deleting one merchandise ID, which is included in the merchandise return action information, from the merchandise information recorded in the sales management table in the database 10 linked to the personal ID. In this way, it is recorded in the database 10 that the person indicated by the personal ID has removed the merchandise from the items to be purchased.

The sales management unit 18 outputs, to the display control unit 19, the personal ID and a sales management information change notification indicating that the sales management table has been updated. Upon receiving the sales management information change notification, the display control unit 19, on the basis of that notification, acquires the terminal ID of a terminal 7 recorded in the person management table, in the database 10, linked to that personal ID. Based on the terminal ID, the display control unit 19 generates sales management information to be transmitted to the terminal 7 (step S115). The sales management information, as one example, may be information including a personal ID, a list of the names, IDs and the like, the number of each item of merchandise, the unit price of each item of merchandise, of merchandise taken in the hand by the person specified by that personal ID and determined as being merchandise to be purchased, and the total monetary amount for all merchandise determined as being merchandise to be purchased.

The display control unit 19 transmits the generated sales management information to the terminal 7 on the basis of the terminal ID (step S116). The terminal ID may be a network address of the terminal 7, an ID assigned to a dedicated application program stored in the terminal 7, or the like. The terminal 7 receives the sales management information and outputs it to a screen. As a result thereof, the sales management information is displayed on the terminal 7 held by the person detected in step S111, and that person is able to see a list of merchandise that is to be purchased by that person in the storefront and the total monetary amount thereof.

The control unit 11 in the storefront device 1 determines whether or not the process is to be ended (step S117). When the process is not to be ended (NO in step S117), the control unit 11 repeats the process from step S101. The processing units in the storefront device 1 perform the above-mentioned processes in parallel for each person, based on information obtained from the sensors provided in the storefront.

In the above-mentioned processes, the sales management unit 18 in the storefront device 1 performs a process for assigning, to sales management information corresponding to the ID of a person specified by the person specifying unit 15, the IDs of merchandise on which movement actions have been performed by that person. However, instead of storing sales management information indicating that the merchandise is to be purchased, the sales management unit 18 may record the merchandise ID information in another data table as merchandise value management information indicating that the person is interested in that merchandise.

Additionally, in the above-mentioned processes, the sales management unit 18 in the storefront device 1 performs a process for assigning, to sales management information corresponding to the ID of a person specified by the person specifying unit 15, the IDs of merchandise on which movement actions for return to merchandise shelves 21 have been performed by that person. However, instead of storing sales management information indicating that the merchandise has been returned, the sales management unit 18 may record the merchandise ID information in another data table as merchandise value management information indicating that the person is interested in, but did not go so far as to purchase, that merchandise.

In the above-mentioned processes in the storefront device 1, a person is specified and merchandise on which a movement action has been performed is specified when just one person is positioned in front of a merchandise shelf 21 and that person acquires the merchandise or returns the merchandise to the merchandise shelf 21. However, even when there are a plurality of people in front of the merchandise shelf 21, a similar process may be used to determine which of the people performed movement actions on which of the merchandise. In this case, the second position information acquisition unit 13 must detect, using range images acquired from each of the motion sensors 4, the skeletal frame information of the people appearing in each range image in a precise manner for each person. The second position information acquisition unit 13 performs the skeletal frame information detection process for each person based on the number of people appearing in a range image such that, the more people appear in a range image, the heavier the processing load in the second position information acquisition unit 13. However, when there is a large processing capacity for a short time in the processing device 1, the skeletal frame information of people appearing in the range image can be detected in a short time. By setting the processing capacity for a short time to be large in the storefront device 1, the detection of feature information for people and the detection of merchandise movement actions can be performed in a short time.

In the above-mentioned processes, a display control unit 19 may specify image data for promotional video images on the basis of the personal ID and the merchandise ID included in sales management information. Based on a personal ID and a merchandise ID included in sales management information, the display control unit 19 specifies, from among a plurality of promotional video images recorded in the database 10, one or a plurality of promotional video images regarding that merchandise or merchandise related to that merchandise. Furthermore, the display control unit 19 acquires image data for the one or the plurality of promotional vides images that have been specified.

The display control unit 19 may implement control to output this image data to the terminal 7 having the terminal ID specified by the personal ID, or to a monitor installed in the storefront 20, on a merchandise shelf 21 near the position of the person indicated by the personal ID.

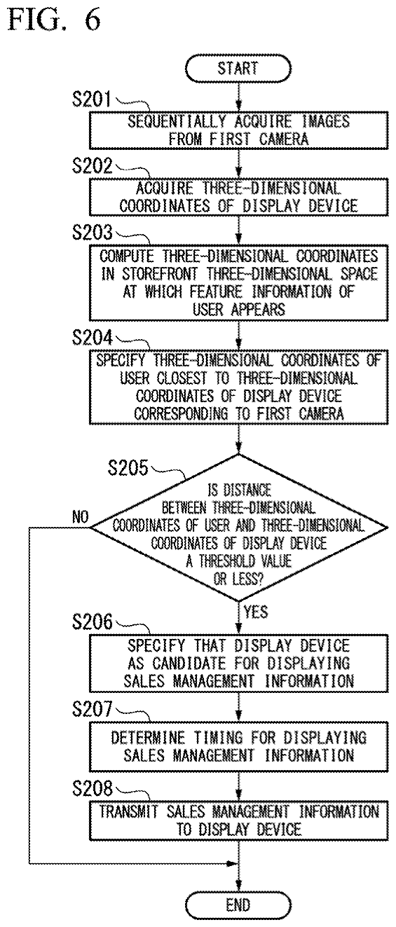

FIG. 6 is a second diagram showing the processing flow in the storefront device.

Due to the above-mentioned processes, information such as merchandise IDs of merchandise taken in the hand by a user in the storefront is collected as sales management information. A user can make a display device 21 installed in the storefront display the sales management information. Specifically, for example, the display device specifying unit 16 sequentially acquires images from a first camera 3 (step S201). The display device specifying unit 16 acquires, from the database 10, the ID of a merchandise shelf 21 recorded so as to be linked to the ID of the first camera 3. The display device specifying unit 16 acquires, from the database 10, the three-dimensional coordinates of the display device 22 that is recorded so as to be linked to the ID of the merchandise shelf 21 (step S202).

On the basis of the coordinates of the location of the feature information of the user appearing in the images obtained from the first camera 3, the display device specifying unit 16 computes the three-dimensional coordinates, in the storefront three-dimensional space, at which that feature information appears (step S203). For example, the display device specifying unit 16 estimates the distance from the first camera 3 to the user on the basis of the length of the spacing between the eyes of the user appearing in an image. The display device specifying unit 16 substitutes the estimated distance, the positions of the eyes in the image, and the shooting direction and angle of view of the first camera 3 into a coordinate computation expression, and as a result thereof, computes the three-dimensional coordinates of the user in the storefront.

The display device specifying unit 16 specifies, from among the three-dimensional coordinates indicated by feature information for one or a plurality of people appearing in the images obtained by the first camera 3, the three-dimensional coordinates of the user closest to the three-dimensional coordinates of the display device 22 corresponding to the first camera 3 (step S204). The display device specifying unit 16 determines whether or not the distance between the three-dimensional coordinates of the specified user and the three-dimensional coordinates of the display device 22 corresponding to the first camera 3 becomes equal to or less than a threshold value (step S205). If the distance between the three-dimensional coordinates indicated by the feature information of the user and the three-dimensional coordinates of the display device 2 corresponding to the first camera 3 becomes equal to or less than the threshold value (YES in step S205), then that display device 22 is specified as a candidate for displaying the sales management information of the specified user (step S206). The display device specifying unit 16 outputs, to the display timing determination unit 17, the ID of the display device 22 specified as the candidate and the ID of the user corresponding to the feature information whose distance from the display device 22 becomes equal to or less than the threshold value. As a result thereof, it is possible to specify a display device on which the sales management information of the user is to be displayed.

The display device specifying unit 16 may use the range images obtained from the motion sensors 4 to specify the three-dimensional coordinates of the user in the storefront, and may specify a display device 22 near the user. Specifically, skeletal frame information is extracted from the range images, and the coordinates of skeletal frame information at a position corresponding to the coordinates of the feature information of the user obtained by the first camera 3 are compared with the coordinates of the display device 22. The display device specifying unit 16 specifies skeletal frame information and a display device 22 for which a distance between the coordinates of the skeletal frame information and the coordinates of the display device 22 is equal to or less than a threshold value. The display device specifying unit 16 outputs, to the display timing determination unit 17, the ID of a user with feature information corresponding to that skeletal frame information, and the ID of that display device 22.

The display timing determination unit 17 determines the timing at which the sales management information is to be displayed on the display device 22 with the ID obtained from the display device specifying unit 16 (step S207). Specifically, the display timing determination unit 17 may determine that the sales management information of the user indicated by the user ID is to be displayed on the display device 22 indicated by that display device ID at the timing by which a set including a display device ID and a user ID are acquired from the display device specifying unit 16. In this case, the display timing determination unit 17 immediately outputs the display device ID and the user ID acquired from the display device specifying unit 16 to the display control unit 19.

Based on the user ID, the display control unit 19 reads the sales management information of the user indicated by the user ID from the sales management table in the database. The display control unit 19 transmits that sales management information to the display device indicated by the display device ID acquired from the display timing determination unit 17 (step S208). The display device 22 receives the sales management information and outputs it to a screen.

The display device 22 comprises a touch sensor such as a touch panel. The display device 22, based on a user touching a touch panel, detects that touch action and transmits, to the storefront device 1, a touch signal including information indicating that it has been touched and a display device ID. The display timing determination unit 17 of the storefront device 1 detects the touch signal and determines whether or not the display device ID specified by the display device specifying unit 16 and the display device ID included in the touch signal match. When the display device IDs match, the display timing determination unit 17 outputs, to the display control unit 19, that display device ID and a user ID grouped with the matched display device ID in the information acquired from the display device specifying unit 16. Based on the user ID, the display control unit 19 reads sales management information of a user indicated by that user ID from the sales management table in the database. The display control unit 19 transmits the sales management information to the display device indicated by the display device ID acquired from the display timing determination unit 17. The display device 22 receives the sales management information and outputs it to the screen.

The display timing determination unit 17 may acquire skeletal frame information on the basis of the range images obtained from the motion sensors 4 in a manner similar to the above, and may use that skeletal frame information to determine a display timing for the sales management information. For example, the display timing determination unit 17 detects information indicating an arm axis or the movement of the position of a hand tip indicated by the skeletal frame information. The display timing determination unit 17 detects that the arm axis is stretched out towards the display device 22 of the display device ID obtained from the display device specifying unit 16. Then, the timing determination unit 17 outputs, to the display control unit 19, the display device ID of the display device 22 positioned in the direction in which the arm axis is extended, and the ID of the user who stretched the arm in that direction. Based on the user ID, the display control unit 19 reads the sales management information of the user indicated by that user ID from the sales management table in the database. The display control unit 19 transmits the sales management information to the display device indicated by the display device ID acquired from the display timing determination unit 17. The display device 22 receives the sales management information and outputs it to the screen

Instead of the above-mentioned processes, the display device specifying unit 16 may detect a gesture by the user requesting display on the display device 22 on the basis of information obtained from a motion sensor 4, and may determine that sales management information should be displayed on the display device 22 on which display was requested by that gesture. The gesture may, for example, be a gesture in which the user directs the user's line of sight towards the display device 22. Furthermore, upon detecting a gesture (a gesture such as directing the user's line of sight) requesting display on the display device 22 on the basis of a motion sensor 4 or image information obtained from a first camera 3, the display timing determination unit 17 may determine that the timing has arrived for displaying sales management information on the display device 22 on which display was requested by the gesture.

According to the above-mentioned processes, the storefront device 1 can display sales management information of a user on a display device 22 installed near that user. As a result thereof, users not possessing their own mobile terminals can check lists of merchandise acquired by those users, the prices of the merchandise, and the total monetary amount of the merchandise appearing on display devices 22 installed in the storefront. Additionally, according to the above-mentioned processes, even when a plurality of users are captured in an image acquired by a first camera 3, it is possible to specify the user closest to the display device 22 as a candidate, and to display the sales management information of that user.

Additionally, according to the above-mentioned processes, each time a user moves and a facing merchandise shelf 21 changes, the storefront device 1 can sequentially move and display the sales management information of that user on a display device 22 provided on the merchandise shelf 21 that is being faced.

In the above-mentioned processes, the storefront device 1 outputs, to a display device 22, sales management information of a user at a prescribed distance or less from the display device 22. However, when a plurality of users appear in an image, the storefront device 1 may output the sales management information for the user, among the the plurality of users, who is at the closest distance from the display device 22. In this case, the display device specifying unit 16 computes the user closest to the display device 22 corresponding to the first camera 3 or the motion sensor 4 on the basis of the coordinates of the display device 22 and the coordinates in the image obtained from the first camera 3 or the motion sensor 4. Thus, the display device specifying unit 16 specifies the person closest to the display device 22 among the people positioned within a prescribed range from one of the plurality of display devices 22.

Additionally, the storefront device 1 may determine the user closest to a merchandise shelf 21 and output the sales management information of that user to a specified display device 22. In this case, in a similar manner, the user closest to the merchandise shelf 21 corresponding to a first camera 3 or a motion sensor 4 is computed on the basis of the coordinates of the merchandise shelf 21 and the coordinates within an image obtained by the first camera 3 or the motion sensor 4. Thus, the display device specifying unit 16 specifies the person closest to the merchandise shelf 21 on which the display device 22 is installed, among the people positioned within a prescribed range from one of the plurality of display devices 22.

Aside from the sales management information, the display control unit 19 may make inferences regarding other related merchandise based on the merchandise indicated by the sales management information, and may output, to the display device 22, promotional information regarding the related merchandise, or map information indicating the storefront position of a merchandise shelf 21 on which the related merchandise is arranged. For example, the display control unit 19 stores, in the database 10, merchandise IDs and related merchandise IDs indicating related merchandise relating to that merchandise. The related merchandise relating to certain merchandise may be merchandise related to the certain merchandise as inferred by using statistical methods on the basis of past purchase information. This inference may be made by the storefront device 1, or may be performed by another communicably connected statistical processing device.

The display control unit 19 may instruct the display device 22 to remove the display of the sales management information output to the display device 22 when a prescribed period of time elapses after a request to display the sales management information. Additionally, the display timing determination unit 17 continually determines the distance from the display device 22 or the merchandise shelf 21 to the user appearing in images obtained from the first camera 3 or range images obtained from the motion sensor 4, and instructs the display control unit 19 to remove the display of the sales management information when the distance increases.

Control may also be implemented to remove the display on the display device 22 on the basis of instructions from the display control unit 19. The display control unit 19 may detect that the line of sight of the user appearing in images obtained from the first camera 3 or range images obtained from the motion sensor 4 is no longer directed at the display device 22, and may implement control to remove the display on the display device 22 in that case.

The display device 22 may receive a change operation for the sales management information that is being displayed. For example, the case in which, when a user has checked the sales management information of that user displayed on the display device 22, the merchandise that has been taken in the hand of the user and placed in a basket or the like, or the number thereof, differs from the merchandise or the number indicated by the sales management information will be discussed. In this case, it is possible to input changes to the merchandise or changes to the number into the display device 22. Additionally, when the sales management information includes merchandise that was not taken in the hand, the user inputs, to the display device 22, an instruction to delete that merchandise from the sales management information. The display device 22 generates a change request on the basis of the input change instruction, and outputs the change request to the storefront device 1. The sales management unit 18 in the storefront device 1 may change the sales management information recorded in the sales management table in the database 10 on the basis of the change request.

For example, when the change request indicates a number change, the change request contains a merchandise ID and the number of items of merchandise. Additionally, when the change request indicates a merchandise change, the change request contains the incorrect merchandise ID and the correct merchandise ID. The sales management unit 18 changes the sales management information so that these change requests agree with the sales management information. When changing the sales management information, the sales management unit 18 may store the ID of the user who made the change request and the content of the change request in the database 10, and may perform an analysis as to whether or not the change request is correct. When the change request is incorrect, the storefront device 1 may record the ID of the user in the database 10 as being fraudulent user information.

In order to allow the above-mentioned change request, the sales management unit 18 may check whether or not the user who made the change request to the display device 22 is the user corresponding to the sales management information on the basis of images obtained from the first cameras 3 or the motion sensors 4. For example, the storefront device 1 may allow the sales management information to be changed on the basis of the change request when the feature information of the user operating the display device 22 obtained from the images matches the feature information of the user corresponding to the sales management information. The storefront device 1 may also allow the change request of the sales management information by another process.

The display control unit 19 may implement control so as to output only information regarding prescribed merchandise in the sales management information displayed by the display device 22. For example, regarding the sales management information displayed on a display device 21 provided on a merchandise shelf 21, the display control unit 19 may implement control so that the display device 21 only displays information regarding merchandise managed in a prescribed area in which that merchandise shelf 21 is located.

As indicated, for example, in FIG. 2, each merchandise shelf 21 installed in the storefront 20 may be arranged so that the position of a face from which merchandise is removed from a certain merchandise shelf 21 is offset from the position of a face from which merchandise is removed from an adjacent merchandise shelf 21. By arranging the merchandise shelves 21 in this manner, the relationship between the merchandise shelves 21 and the users appearing in each image is made clear when determining which user took which merchandise in the hand on the basis of images obtained by the first cameras 3 for capturing the feature information of the users or the second cameras 5 for capturing the merchandise taken in the hand by the users. As a result thereof, the difficulty of making the determination can be lowered. For example, when a user positioned at the end of a certain merchandise shelf 21 takes in the hand merchandise from a merchandise shelf 21 positioned adjacent to that merchandise shelf 21, it is possible to reduce the processing power required to determine, on the basis of images, whether the user has acquired merchandise from the adjacent merchandise shelf 21, which is different from the merchandise shelf 21 that the user is facing.

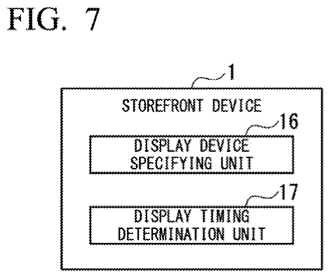

FIG. 7 is a diagram illustrating the minimum configuration of the storefront device.

It is sufficient for the storefront device 1 to be provided with at least a display device specifying unit 16 and a display timing determination unit 17.

The display device specifying unit 16 specifies, from among a plurality of display devices 22 provided in a storefront 20, a display device 22 that is to display sales management information indicating merchandise acquired in the storefront 20 by a processing subject person detected in the storefront 20.

The display timing determination unit 17 determines the timing at which the sales management information is to be displayed on the specified display device.

Each of the above-mentioned devices has a computer system in the interior thereof. Additionally, the steps in each of the above-mentioned processes may be stored, in the form of programs, in computer-readable recording media, and these programs may be read into and executed by a computer to perform the above-mentioned processes. In this case, computer-readable recording media refer to magnetic disks, magneto-optic disks, CD-ROMs, DVD-ROMs, semiconductor memory devices and the like. Additionally, these computer programs may be distributed to computers by means of communication lines, and the programs may be executed by the computers receiving the distributed programs.

Additionally, the above-mentioned programs may be for realizing some of the aforementioned functions.

Furthermore, the aforementioned functions may be implemented by so-called difference files (difference programs) that can be realized by being combined with programs that are already recorded on a computer system.

Some or all of the above-mentioned embodiments could be described as in the following supplementary notes, but they are not limited to the following supplementary notes.

### (Supplementary Note 1)

A storefront device comprising:

a display device specifying unit configured to specify, among a plurality of display devices, a display device for displaying sales management information indicating merchandise acquired in a storefront by a processing subject person detected in the storefront; and

a display timing determination unit configured to determine a timing at which the sales management information is to be displayed on the specified display device.

### (Supplementary Note 2)

The storefront device according to Supplementary Note 1, comprising:

a person specifying unit configured to specify, as the processing subject person, a person positioned within a prescribed range from one of the plurality of display devices.

### (Supplementary Note 3)

The storefront device according to Supplementary Note 2, wherein the person specifying unit specifies, as the processing subject person, a person who is closest to the display device among people positioned within the prescribed range.

### (Supplementary Note 4)

The storefront device according to Supplementary Note 2, wherein the person specifying unit specifies, as the processing subject person, a person who is closest to a merchandise shelf on which the display device is provided among people positioned within the prescribed range.

### (Supplementary Note 5)

The storefront device according to any one of Supplementary Notes 2 to 4, wherein:

the person specifying unit specifies the processing subject person based on feature information of the person obtained from an image, captured by an image capture device, in which one or a plurality of people appear.

### (Supplementary Note 6)

The storefront device according to any one of Supplementary Notes 1 to 5, wherein:

when a touch sensor provided on the display device detects a touch, the display device specifying unit specifies the display device on which the touch sensor is provided as the display device on which the sales management information is to be displayed; and

when the touch sensor detects the touch, the display timing determination unit determines that the timing has arrived for displaying the sales management information on the display device on which the touch sensor is provided.

### (Supplementary Note 7)

The storefront device according to any one of Supplementary Notes 1 to 5, wherein:

the display device specifying unit detects a gesture requesting display on the display device based on information obtained from a motion sensor sensing motions of people, and specifies, as the display device on which the sales management information is to be displayed, the display device on which display was requested by the gesture; and

when the gesture requesting display on the display device is detected based on information obtained from the motion sensor, the display timing determination unit determines that the timing has arrived for displaying the sales management information on the display device on which the display was requested by the gesture.

### (Supplementary Note 8)

The storefront device according to any one of Supplementary Notes 1 to 7, comprising:

a display control unit configured to implement control to transmit the sales management information to the display device and display the sales management information, and that provide an instruction to remove the sales management information to the display device displaying the sales management information based on a prescribed operation by the processing subject person.

### (Supplementary Note 9)

The storefront device according to any one of Supplementary Notes 1 to 8, comprising:

a sales management unit configured to acquire, from the display device, a change in the merchandise and a number of the merchandise indicated by the sales management information displayed on the display device, and change the sales management information.

### (Supplementary Note 10)

A storefront system comprising:

a storefront device configured to specify, among a plurality of display devices, a display device for displaying sales management information indicating merchandise acquired in a storefront by a processing subject person detected in the storefront, and determine a timing at which the sales management information is to be displayed on the specified display device.

### (Supplementary Note 11)

A storefront management method comprising:

specifying, among a plurality of display devices, a display device for displaying sales management information indicating merchandise acquired in a storefront by a processing subject person detected in the storefront; and

determining a timing at which the sales management information is to be displayed on the specified display device.

### (Supplementary Note 12)

A program for causing a computer of a storefront device to execute processes, the processes comprising:

specifying, among a plurality of display devices, a display device for displaying sales management information indicating merchandise acquired in a storefront by a processing subject person detected in the storefront; and

determining a timing at which the sales management information is to be displayed on the specified display device.

Priority is claimed on Japanese Patent Application No. 2017-162610, filed Aug. 25, 2017, the disclosure of which is incorporated herein by reference.

### INDUSTRIAL APPLICABILITY

According to the present invention, it is possible for a person visiting a storefront to purchase merchandise while viewing, in display devices in the storefront, sales management information including at least a list of the names of merchandise taken in the hand of that person.

### REFERENCE SIGNS LIST

1 Storefront device
2 Entrance/exit gate
3 First camera
4 Motion sensor
5 Second camera
6 Merchandise detection sensor
7 Terminal
10 Database
11 Control unit
12 First position information acquisition unit
13 Second position information acquisition unit
14 Action detection unit
15 Person specifying unit
16 Display device specifying unit
17 Display timing determination unit
18 Sales management unit
19 Display control unit
20 Storefront
21 Merchandise shelf
22 Display device
23 Gate device

1. A storefront device comprising:
a display device specifying unit configured to specify, among a plurality of display devices, a display device for displaying sales management information indicating merchandise acquired in a storefront by a processing subject person detected in the storefront; and
a display timing determination unit configured to determine a timing at which the sales management information is to be displayed on the specified display device.

2. The storefront device according to claim 1, comprising:
a person specifying unit configured to specify, as the processing subject person, a person positioned within a prescribed range from one of the plurality of display devices.

3. The storefront device according to claim 2, wherein the person specifying unit specifies, as the processing subject person, a person who is closest to the display device among people positioned within the prescribed range.

4. The storefront device according to claim 2, wherein the person specifying unit specifies, as the processing subject person, a person who is closest to a merchandise shelf on which the display device is provided among people positioned within the prescribed range.

5. The storefront device according to claim 2, wherein:
the person specifying unit specifies the processing subject person based on feature information of the person obtained from an image, captured by an image capture device, in which one or a plurality of people appear.

6. The storefront device according to claim 1, wherein:
when a touch sensor provided on the display device detects a touch, the display device specifying unit specifies the display device on which the touch sensor is provided as the display device on which the sales management information is to be displayed; and
when the touch sensor detects the touch, the display timing determination unit determines that the timing has arrived for displaying the sales management information on the display device on which the touch sensor is provided.

7. The storefront device according to claim 1, wherein:
the display device specifying unit detects a gesture requesting display on the display device based on information obtained from a motion sensor sensing motions of people, and specifies, as the display device on which the sales management information is to be displayed, the display device on which display was requested by the gesture; and
when the gesture requesting display on the display device is detected based on information obtained from the motion sensor, the display timing determination unit determines that the timing has arrived for displaying the sales management information on the display device on which the display was requested by the gesture.

8. A storefront system comprising:
a storefront device configured to specify, among a plurality of display devices, a display device for displaying sales management information indicating merchandise acquired in a storefront by a processing subject person detected in the storefront, and determine a timing at which the sales management information is to be displayed on the specified display device.

9. A storefront management method comprising:
specifying, among a plurality of display devices, a display device for displaying sales management information indicating merchandise acquired in a storefront by a processing subject person detected in the storefront; and
determining a timing at which the sales management information is to be displayed on the specified display device.

10. (canceled)
